(19) United States
(12) Patent Application Publication
(10) Pub. No.: US 2026/0016871 A1
(43) Pub. Date: Jan. 15, 2026

(54) METHOD AND SYSTEM FOR PEER-TO-PEER ENERGY TRANSFER TO MITIGATE THERMAL PROPAGATION AND INCREASE RECHARGEABLE ENERGY STORAGE SYSTEM (RESS) LONGEVITY

(71) Applicant: GM Global Technology Operations LLC, Detroit, MI (US)

(72) Inventors: Justin Anthony Bunnell, Cary, NC (US); Girish Ghatikar, Riverside, CA (US)

(73) Assignee: GM Global Technology Operations LLC, Detroit, MI (US)

(21) Appl. No.: 18/770,147

(22) Filed: Jul. 11, 2024

(51) Int. Cl. G06F 1/20; G06F 1/3296

(52) U.S. Cl. CPC G06F 1/206; G06F 1/3296

(57) ABSTRACT

A system and method includes receiving a depletion request from a host peer connected to a peer communications network, the depletion request indicating that the host peer is experiencing a rechargeable energy storage system (RESS) event and including a desired power to discharge and a duration of the discharge. The system and method also include identifying one or more recipient peers each connected to the peer communications network, each recipient peer having an availability to accept the discharge, and executing the depletion request by instructing the host peer to discharge the power and the one or more recipient peers to accept the discharged power simultaneously such that zero net current passes through an electrical grid in connection with the host peer and the one or more recipient peers.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to energy storage and charging systems for electric vehicles. In particular, a rechargeable energy storage system (RESS) for an electric vehicle may be at risk of a thermal propagation event or accelerated degradation that permanently damages the RESS and may do significant damage to the body of the electric vehicle and/or the surroundings of the electrical vehicle. Here, the additional energy in a RESS at a high state of charge may accelerate thermal propagation and/or degradation of the RESS faster than a RESS at a low state of charge.

In existing systems, the power from a RESS at a high state of charge may be shuttled to other devices within a home environment of the electric vehicle, or shuttled back to a public utility, as permitted, to mitigate the effects of the thermal propagation event. Here, the RESS is part of a facility network (e.g., electric vehicles, stationary storage devices, etc.) that forms a peer. To this end, the peer may be connected via a single connection (e.g., a smart inverter) that connects to an electrical grid. Notably, it is desirable and effective to shuttle the power between peers (i.e., other facility networks connected to the electrical grid via respective smart inverters), where one or more recipient peers can accept the power that needs to be shuttled, can store/use the power, or discharge the power for the host peer experiencing or about to experience a thermal propagation event or accelerated degradation of the RESS. Moreover, shuttling power between peers may be effectively invisible to the public utility, and/or create local markets for power between peers.

### SUMMARY

One aspect of the disclosure provides a computer-implemented method for peer-to-peer energy transfer to mitigate rechargeable energy storage system (RESS) events and increase RESS longevity that when executed on data processing hardware causes the data processing hardware to perform operations that include receiving a depletion request from a host peer connected to a peer communications network, the depletion request indicating that the host peer is experiencing a rechargeable energy storage system (RESS) event and including a desired power to discharge and a discharge duration. The operations also include identifying one or more recipient peers each connected to the peer communications network, each recipient peer having an availability to accept the desired power to discharge. The operations further include executing a depletion process by instructing the host peer to discharge the power and the one or more recipient peers to accept the discharged power simultaneously such that zero (0) net current passes through an electrical grid in connection with the host peer and the one or more recipient peers.

Implementations of the disclosure may include one or more of the following optional features. In some implementations, the depletion request further includes a desired start time of the discharge. In these implementations, each respective availability to accept the desired power of the one or more recipient peers may include an available time period to accept the discharge. Here, the available time period to accept the discharge is aligned with the desired start time of the discharge. In some examples, the RESS event includes one of thermal propagation of a RESS of the host peer and accelerated degradation of the RESS of the host peer.

In some implementations, each respective availability to accept the desired power of the one or more recipient peers includes a type of availability to accept the discharge. Here, the type of availability to accept power includes a useful load and a wasteful load. In these implementations, identifying the one or more recipient peers may include prioritizing recipient peers having the type of availability for a useful load. In some examples, the operations further include, while executing the depletion process, receiving a fault indication from one of the one or more recipient peers, and halting execution of the depletion process.

In some implementations, the operations further include receiving a subsequent depletion request from an additional host peer different from the host peer, and executing the depletion process and a subsequent depletion process simultaneously. In these implementations, the depletion process and the subsequent depletion process may share the same one or more recipient peers. In some examples, the host peer includes a vehicle.

Another aspect of the disclosure provides a system for peer-to-peer energy transfer to mitigate RESS events and increase RESS longevity that includes data processing hardware and memory hardware in communication with the data processing hardware. The memory hardware stores instructions that when executed by the data processing hardware cause the data processing hardware to perform operations that include receiving a depletion request from a host peer connected to a peer communications network, the depletion request indicating that the host peer is experiencing a rechargeable energy storage system (RESS) event and including a desired power to discharge and a discharge duration. The operations also include identifying one or more recipient peers each connected to the peer communications network, each recipient peer having an availability to accept the desired power to discharge. The operations further include executing a depletion process by instructing the host peer to discharge the power and the one or more recipient peers to accept the discharged power simultaneously such that zero (0) net current passes through an electrical grid in connection with the host peer and the one or more recipient peers.

This aspect may include one or more of the following optional features. In some implementations, the depletion request further includes a desired start time of the discharge. In these implementations, each respective availability to accept the desired power of the one or more recipient peers may include an available time period to accept the discharge. Here, the available time period to accept the discharge is aligned with the desired start time of the discharge. In some examples, the RESS event includes one of thermal propagation of a RESS of the host peer and accelerated degradation of the RESS of the host peer.

In some implementations, each respective availability to accept the desired power of the one or more recipient peers includes a type of availability to accept the discharge. Here, the type of availability to accept power includes a useful load and a wasteful load. In these implementations, identifying the one or more recipient peers may include prioritizing recipient peers having the type of availability for a useful load. In some examples, the operations further include, while executing the depletion process, receiving a fault indication from one of the one or more recipient peers, and halting execution of the depletion process.

In some implementations, the operations further include receiving a subsequent depletion request from an additional host peer different from the host peer, and executing the depletion process and a subsequent depletion process simultaneously. In these implementations, the depletion process and the subsequent depletion process may share the same one or more recipient peers. In some examples, the host peer includes a vehicle.

The details of one or more implementations of the disclosure are set forth in the accompanying drawings and the description below. Other aspects, features, and advantages will be apparent from the description and drawings, and from the claims.

### BRIEF DESCRIPTION OF THE DRAWINGS

The drawings described herein are for illustrative purposes only of selected configurations and are not intended to limit the scope of the present disclosure.

FIG. 1 is a schematic view of an example system for peer-to-peer energy transfer to mitigate rechargeable energy storage system (RESS) events and increase RESS longevity.

FIG. 2 is a schematic view of example components of the system of FIG. 1.

FIG. 3 is a flowchart of an example arrangement of operations for a method for peer-to-peer energy transfer to mitigate thermal propagation and increase RESS longevity.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

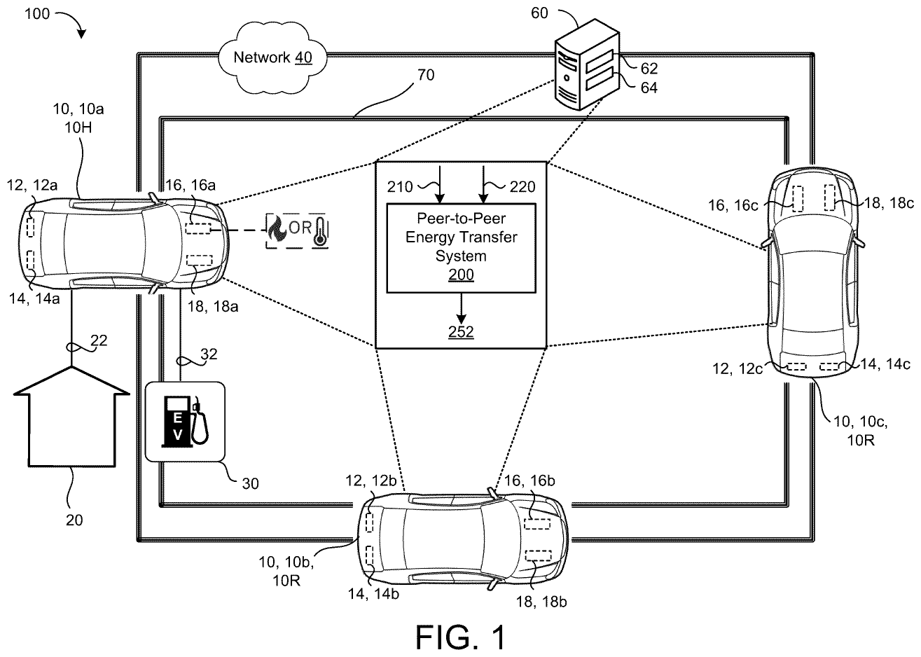

Referring to FIG. 1, in some implementations, a system 100 includes a plurality of peers 10, 10a-n in communication with one another via a peer communications network 40. Additionally, the system 100 includes a remote system 60 in communication with the plurality of peers 10 via the peer communications network 40. Each peer 10 may be generally defined as a group of electrical devices and/or loads connected to one another (e.g., within a facility network), in which there is a single connection (e.g., a smart inverter 18) that connects the peer 10 to an electrical grid 70. Within the facility network of the peer 10, there may be electric vehicles or stationary storage devices (e.g., home networks and/or stationary charging devices).

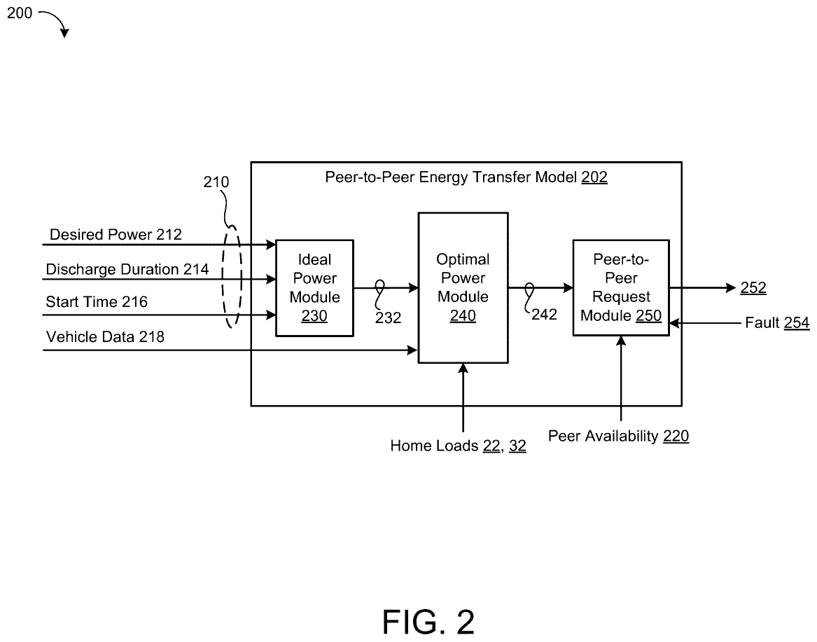

As shown, the peers 10 and/or the remote system 60 execute a peer-to-peer energy transfer system 200 (FIG. 2). Briefly, and as described in further detail below, the peer-to-peer energy transfer system 200 is configured to receive a depletion request 210 indicating that a host peer 10H is experiencing a rechargeable energy storage system (RESS) event, and execute a depletion process 252 by instructing the host peer 10H to discharge the power and one or more recipient peers 10R to accept the discharged power simultaneously such that zero (0) net current passes through an electrical grid 70 in connection with the host peer 10H and the one or more recipient peers 10R. A RESS event may refer to a thermal propagation event (i.e., imminent catastrophic failure) of a RESS 16 of the host vehicle 10H, or an accelerated degradation of the RESS 16 due to a high state of charge (SOC) and/or high temperature of the RESS 16. Notably, executing a simultaneous discharge and acceptance of power such that zero net current passes through the electrical grid 70 allows the depletion process 252 to be largely invisible to a utility operating the electrical grid 70. Moreover, by sharing the depletion request 210 with the one or more recipient peers 10R, additional pathways for shuttling power from the host peer 10H and a larger sink (i.e., formed by the one or more recipient peers 10R) are available to the host peer 10H to minimize the damage to the RESS 16 of the host peer 10H from thermal propagation or accelerated degradation.

In the example shown, each peer 10a-10c includes a vehicle including a respective rechargeable energy storage system (RESS) 16a-16c (also referred to as a battery 16a-16c) and a respective inverter 18a-18c. However, it should be appreciated that the inverter 18 may be disposed outside of the vehicle and serve as a single gateway to the electrical grid 70 for the vehicle as well as any additional electrical devices and/or electrical loads. The vehicle may include any electrified propulsion system (e.g., fully electric, hybrid, fuel cell, etc.), and may refer to automobiles, trucks farm equipment, trains, aircraft, and the like. The inverter 18 may include a smart bidirectional inverter capable of charging and/or storing energy in the RESS 16. While each peer 10 includes a vehicle, the peer 10 may additionally include any computing device equipped with a RESS 16 such as, without limitation, a stationary storage device and/or other devices within a local household of the peer 10. For example, the peer 10a includes a vehicle, a local household 20 and a stationary storage device 30 in communication with one another. While FIG. 1 shows three (3) peers 10a, 10b, 10c, it should be appreciated that additional peers 10 may be connected to the peer communications network 40. Each of the peers 10a-10c additionally includes respective data processing hardware 12a-12c and memory hardware 14a-14c storing instructions that when executed on the data processing hardware 12 cause the data processing hardware 12 to perform operations. The remote system 60 (e.g., server, cloud computing environment) also includes data processing hardware 62 and memory hardware 64 storing instructions that when executed on the data processing hardware 62 cause the data processing hardware 62 to perform operations. In some examples, execution of the peer-to-peer energy transfer system 200 is shared across the peers 10 and the remote system 60. In other examples, the remote system 60 executes the peer-to-peer energy transfer system 200, where the remote system 60 operates as a central host/controller. In additional examples, the peer-to-peer energy transfer system 200 is executed on one or more of the peers 10 (i.e., is shared across one or more of the peers 10)

The peer communications network 40 may include a wireless local area network (WLAN) that facilitates communication and interoperability among the peers 10 and the remote system 60. In the example shown, the peers 10 within the system 100 are all in communication with one another and the remote system 60 via the peer communications network 40. The peer-to-peer energy transfer system 200 may communicate with each of the peers 10 and/or the remote system 60 via wireless or wired communications technologies and/or protocols. Thus, the peer communications network 40 can include Wireless Fidelity (WiFi) (e.g., IEEE 802.11), Low-Rate Wireless Personal Area Networks (e.g., IEEE 802.15.4), worldwide interoperability for microwave access (WiMAX), 3G, 4G, Long Term Evolution (LTE), 5G, digital subscriber line (DSL), Bluetooth, Near Field Communication (NFC), or any other wireless standards, or Ethernet (e.g., IEEE 802.3). The system 100 may additionally include one or more access points (AP) (not shown) configured to facilitate wireless communication between the peers 10 and/or the remote system 60. Additionally, the peers 10 are in communication and interoperability with one another via the electrical grid 70. In some implementations, the electrical grid 70 is operated and regulated by a public utility company.

Referring to FIGS. 1 and 2, the peer-to-peer energy transfer system 200 may execute a peer-to-peer energy transfer model 202 including an ideal power module 230, an optimal power module 240, and a peer-to-peer request module 250. As shown, the peer-to-peer energy transfer model 202 is configured to receive the depletion request 210 from a host peer 10H (i.e., peer 10a) connected to the peer communications network 40. The depletion request 210 may indicate that the host peer 10H is experiencing a RESS event and include a desired power 212 to discharge and a discharge duration 214. In some implementations, the depletion request 210 further includes a desired start time 216 of the discharge.

As used herein, a RESS event refers to a safety issue with the RESS 16 of the peer 10. For example, one or more cells in the RESS 16 may catch fire and cause the nearby cells in the RESS 16 to also catch fire. Here, the initial cell to catch fire might do so from a manufacturing defect such as an internal short circuit or from overheating above a designed temperature limit of the cell. If the initial cell catches fire and no remedial actions are taken to mitigate the cell to cell ignition chain (i.e., thermal propagation), this may cause the entire RESS 16 to catch fire. One such remedial action here includes depleting the RESS 16 to below a state of charge at which thermal propagation ceases. A RESS 16 at a lower state of charge has less stored energy, and thus less energy to fuel the thermal propagation. As such, a RESS 16 at a high state of charge may catch fire more rapidly than a RESS 16 at a lower state of charge. In some implementations, the host peer 10H may generate the depletion request 210 in response to detecting gas (e.g., indicating hydrogen being expelled from a cell), and/or erratic cell voltage readings. In another example, the RESS 16 may be at risk of accelerated degradation. For instance, a RESS 16 may generally have a specific tolerance for voltages, state of charge (SOC), and temperature. Here, the particular RESS 16 may experience a greater rate of capacity degradation at higher SOCs and/or higher temperatures. A remedial action here to avoid this accelerated degradation includes depleting the RESS 16 to below a state of charge at which the accelerated degradation is minimized or eliminated. In some implementations, depleting the RESS 16 occurs when the RESS 16 takes a long time to cool, and/or lacks active cooling components to protect the RESS 16 from high temperatures.

In some implementations, the ideal power module 230 receives, as input, the depletion request 210 including the desired power 212, the discharge duration 214, and the desired start time 216, and generates, as output, an ideal power 232 of the depletion request 210. The desired power 212 may include a difference between the current state of energy (SOE) of the RESS 16, and a safe SOE of the RESS 16. The discharge duration 214 may include a period of time (e.g., 15 minutes) that the host peer 10H needs to discharge the power. The desired start time 216 generally refers to a time (e.g., 4:00 pm EST) at which the power discharge to the electrical grid 70 will occur. The ideal power 232 of the depletion request 210 may be expressed, as follows:

$$\frac{( {SOE}_{initial} - {SOE}_{safe} ) * Total Battery Energy ( kWh )}{Discharge Duration} = Ideal Power . \qquad ( 1 )$$

Where SOEᵢₙᵢₜᵢₐₗ denotes the current SOE of the RESS 16, and SOE_{safe} denotes a safety threshold of the RESS 16 where the RESS 16 is less reactive to RESS events. In some implementations, the SOE_{safe} is zero (0). Additionally, total battery energy denotes the total kWh of the RESS 16, where multiplying the total battery energy by the change in SOE represents the desired energy to discharge. Dividing the desired energy by the discharge duration 214 then provides the ideal power 232 expressed as an ideal power withdrawal rate from the RESS 16 to safely mitigate the RESS event.

The optimal power module 240 receives the ideal power 232 output by the ideal power module 230, and generates, as output, an optimal power 242 for the system 100. Here, rather than the ideal power 232, the optimal power 242 may be shared with/broadcast to the other peers 10 in communication with the host peer 10H via the peer communications network 40. The optimal power module 240 further receives, as input, vehicle data 218 of the host peer 10H such as, without limitation, the discharge capability of the RESS 16, the discharge capability of the inverter 18 connected to the RESS 16, the power capability of an inverter connected to the electrical grid 70, and/or any of loads in the household of the host peer 10 that are being powered by electricity supplied by a utility. In the example shown in FIG. 1, the host peer 10H is connected to the local household 20 and the stationary storage device 30. The local household 20 may communicate a home load 22 (e.g., water heater, HVAC system, and/or other appliances), while the stationary storage device 30 may communicate a home load 32 indicating a capacity for accepting discharged power. Here, the optimal power 242 may be expressed as follows:

$$Optimal Power = min ( Inverter Power Limit , ( min ( IdealPower , RESS Discharge Power Limit ) - Home Loads ) , 0 ) . \qquad ( 2 )$$

where the Inverter Power Limit denotes the discharge capability of the inverter 18, the RESS Discharge Power Limit refers to the discharge capability of the RESS 16, and the Home Loads denotes the respective home loads 22, 32 of the local household 20 and the stationary storage device 30. Here, the optimal power 242 modulates the ideal power 232 by balancing the ideal power 232 needed to make the RESS 16 safe, with the power capabilities of the inverter 18, the discharge capabilities of the RESS 16, and the useful and steady state loads (e.g., the local household 20 and/or the stationary storage device 30) within a network of the host peer 10H. In some implementations, the optimal power 242 foregoes consideration of the Home Loads, and instead seeks to discharge the power to recipient peers 10 that may pay a premium for the discharged power.

The peer-to-peer request module 250 receives the optimal power 242 generated by the optimal power module 240, identifies one or more of the peers 10 in the peer communications network 40 as recipient peers 10R, and generates the depletion process 252 that instructs the host peer 10H to discharge its power and the one or more identified recipient peers 10R to accept the power discharged by the host peer 10H simultaneously. Here, the peer-to-peer request module 250 may further receive, from peers 10 in the peer communications network 40, respective availabilities 220 to accept the desired power 212 (i.e., the optimal power 242). The availabilities 220 may include the available power and time period to accept the desired power 212 and/or a type of availability of the peer 10. In some examples, the peer-to-peer request module 250 identifies one or more recipient peers 10R when the respective availability 220 of the peer 10 includes an available time period to accept the discharge that aligns with the desired start time 216 of the discharge. The type of availability of the peer 10 may include a useful load (e.g., charging an RESS or displacing power that would otherwise be pulled from a utility), or a wasteful load (e.g., unnecessarily running electrical equipment that creates heat ejected into the atmosphere). In some implementations, only one peer 10 is identified as a recipient peer 10R for the depletion request 210, where the power transfer is a one-to-one. In other implementations, more than one peer 10 is identified as a recipient peer 10R for the depletion request 210, where the power transfer is a one-to-many.

When generating the depletion process 252, the peer-to-peer request module 250 may identify recipient peers 10R that include availabilities 220 for a useful load, where any remaining power to be transferred/discharged may be considered for recipient peers 10R that include availabilities for a wasteful load. In other words, the peer-to-peer request module 250 may prioritize peers 10 having the type of availability 220 of a useful load. In particular, the depletion process 252 may be defined, as follows:

$$Actual Request = min ( \text{} Optimal \text{} Power , \text{} {\sum }_{i = 1}^{n} Recipient {Peer}_{i} ( Useful Loads + Wasteful Loads ) . \qquad ( 3 )$$

where n denotes the number of identified recipient peers 10R, and Useful Loads and Wasteful Loads denote the respective availabilities of recipient peers 10R. The depletion process 252, when executed by the peer-to-peer energy transfer model 202, instructs the host peer 10H to discharge the power and the identified recipient peers 10R to accept the discharged power simultaneously. Here, the sum of the power sent to and pulled from the electrical grid 70 sums to zero (0) at any point in time during the discharge duration 214.

In some implementations, after initiating execution of the depletion process 252, the peer-to-peer energy transfer model 202 receives a fault indication 254 from one of the recipient peers 10R. Here, the fault indication 254 may indicate that the recipient peer 10R cannot meet its agreed upon power transfer (e.g., as set forth in the depletion process 252). For example, the recipient peer 10R may measure its actual load vs. an agreed upon load in the depletion process 252, and communicate, via the peer communications network 40, that the recipient peer 10R is not meeting the needed power transfer. In response to receiving the fault indication 254, the peer-to-peer energy transfer model 202 may take immediate remedial action of halting the power transfer between the host peer 10H and the one or more recipient peers 10R.

Notably, while the implementations herein have been described with respect to a single host peer 10H (i.e., peer 10a) executing the depletion process 252, it should be understood that the peer-to-peer energy transfer system 200 may handle multiple depletion requests 210 and depletion processes 252 simultaneously. For example, one host peer 10H to one recipient peer 10R, one host peer 10H to many recipient peers 10R, many host peers 10H to many recipient peers 10R, and/or many host peers 10H to one recipient peer 10R. In some implementations, the peer-to-peer energy transfer model 202 receives a subsequent depletion request 210 from an additional host peer 10H different from the host peer 10H, and executes the depletion process 252 and a subsequent depletion process 252 simultaneously. Here, the depletion process 252 and the subsequent depletion process 252 may identify and engage the same recipient peers 10R.

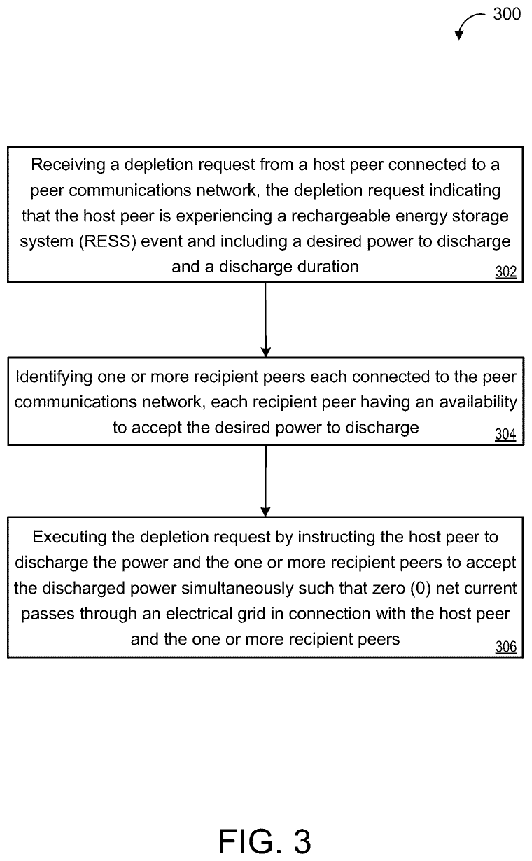

FIG. 3 includes a flowchart of an example arrangement of operations for a method 300 for peer-to-peer energy transfer to mitigate rechargeable energy storage system (RESS) events and increase RESS longevity. The method 300 may be described with reference to FIGS. 1 and 2. Data processing hardware (e.g., data processing hardware 12a-12c, 62 of FIG. 1) may execute instructions stored on memory hardware (e.g., memory hardware 14a-14c, 64 of FIG. 1) to perform the example arrangement of operations for the method 300.

At operation 302, the method 300 includes receiving a depletion request 210 from a host peer 10H connected to a peer communications network 40. The depletion request 210 indicates that the host peer 10H is experiencing a RESS event and includes a desired power 212 to discharge and a discharge duration 214. At operation 304, the method 300 also includes identifying one or more recipient peers 10R each connected to the peer communications network 40. Here, each recipient peer 10R has an availability 220 to accept the desired power 212 to discharge. The method 300 also includes, at operation 306, executing a depletion process 252 by instructing the host peer 10H to discharge the power and the one or more recipient peers 10R to accept the discharged power simultaneously such that zero (0) net current passes through an electrical grid 70 in connection with the host peer 10H and the one or more recipient peers 10R.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A computer-implemented method when executed on data processing hardware causes the data processing hardware to perform operations comprising:
receiving a depletion request from a host peer connected to a peer communications network, the depletion request indicating that the host peer is experiencing a rechargeable energy storage system (RESS) event and including a desired power to discharge and a discharge duration;
identifying one or more recipient peers each connected to the peer communications network, each recipient peer having an availability to accept the desired power to discharge; and
executing a depletion process by instructing the host peer to discharge the power and the one or more recipient peers to accept the discharged power simultaneously such that zero (0) net current passes through an electrical grid in connection with the host peer and the one or more recipient peers.

2. The method of claim 1, wherein the depletion request further includes a desired start time of the discharge.

3. The method of claim 2, wherein each respective availability to accept the desired power of the one or more recipient peers includes an available time period to accept the discharge, the available time period to accept the discharge aligning with the desired start time of the discharge.

4. The method of claim 1, wherein the RESS event includes one of thermal propagation of a RESS of the host peer and accelerated degradation of the RESS of the host peer.

5. The method of claim 1, wherein each respective availability to accept the desired power of the one or more recipient peers includes a type of availability to accept the discharge, the type of availability to accept power including a useful load and a wasteful load.

6. The method of claim 5, wherein identifying the one or more recipient peers comprises prioritizing recipient peers having the type of availability for a useful load.

7. The method of claim 1, wherein the operations further comprise, while executing the depletion process:
receiving a fault indication from one of the one or more recipient peers; and
halting execution of the depletion process.

8. The method of claim 1, wherein the operations further comprise:
receiving a subsequent depletion request from an additional host peer different from the host peer; and
executing the depletion process and a subsequent depletion process simultaneously.

9. The method of claim 8, wherein the depletion process and the subsequent depletion process share the same one or more recipient peers.

10. The method of claim 1, wherein the host peer comprises a vehicle.

11. A system comprising:
data processing hardware; and
memory hardware in communication with the data processing hardware, the memory hardware storing instructions that when executed on the data processing hardware cause the data processing hardware to perform operations comprising:
receiving a depletion request from a host peer connected to a peer communications network, the depletion request indicating that the host peer is experiencing a rechargeable energy storage system (RESS) event and including a desired power to discharge and a discharge duration;
identifying one or more recipient peers each connected to the peer communications network, each recipient peer having an availability to accept the desired power to discharge; and
executing a depletion process by instructing the host peer to discharge the power and the one or more recipient peers to accept the discharged power simultaneously such that zero (0) net current passes through an electrical grid in connection with the host peer and the one or more recipient peers.

12. The system of claim 11, wherein the depletion request further includes a desired start time of the discharge.

13. The system of claim 12, wherein each respective availability to accept the desired power to discharge of the one or more recipient peers includes an available time period to accept the discharge, the available time period to accept the discharge aligning with the desired start time of the discharge.

14. The system of claim 11, wherein the RESS event includes one of thermal propagation of a RESS of the host peer and accelerated degradation of the RESS of the host peer.

15. The system of claim 11, wherein each respective availability to accept the desired power to discharge of the one or more recipient peers includes a type of availability to accept the discharge, the type of availability to accept the discharge including a useful load and a wasteful load.

16. The system of claim 15, wherein identifying the one or more recipient peers comprises prioritizing recipient peers having the type of availability for a useful load.

17. The system of claim 11, wherein the operations further comprise, while executing the depletion process:
receiving a fault indication from one of the one or more recipient peers; and
halting execution of the depletion process.

18. The system of claim 11, wherein the operations further comprise:
receiving a subsequent depletion request from an additional host peer different from the host peer; and
executing the depletion process and a subsequent depletion process simultaneously.

19. The system of claim 18, wherein the depletion process and the subsequent depletion process share the same one or more recipient peers.

20. The system of claim 11, wherein the host peer comprises a vehicle.
